(19) United States
(12) Patent Application Publication
(10) Pub. No.: US 2009/0201663 A1
(43) Pub. Date: Aug. 13, 2009

(54) Lighting installation for grill stove

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/068,884

(22) Filed: Feb. 13, 2008

(51) Int. Cl. F21V 33/00; A47J 37/07; F21S 6/00

(52) U.S. Cl. 362/92; 126/25 R; 362/431

(57) ABSTRACT

A lighting installation for grill stove, which is positioned on a platform with a fixing surface arranged of the grill stove, comprising a base and a light set on the base, wherein the base is positioned on the platform with a fixing surface arranged by a fastening piece and is removable as required. The invention is applicable to a platform with a fixing surface arranged made of any material, not limited to magnetic materials as the base of the invention is fixed by the fastening piece; meanwhile, the fastening piece is designed to be flexibly removed, the lighting installation of the invention is easily to be installed or dismounted as required.

### BACKGROUND OF THE INVENTION

(a) Field of the Invention

The present invention is related to a lighting installation for grill stove, and more particularly, to one that is convenient for a user.

(b) Description of the Prior Art

Barbecue has become increasingly popular among general public in recent years. To bring a warm and fragrant atmosphere for barbecue, such an activity generally conducted outdoors in the evening, therefore, additional lights are required to ensure the barbecue is enjoyable.

Nevertheless, a grill stove generally is not equipped with a lighting installation. Consequently, a grill stove light of a prior art mainly comprises a stand which is positioned on a lateral side of the grill stove; wherein the stand has a magnet attached to the lateral side of the grill stove and a separate power source for lighting set inside the stand. Therefore, a user is able to attach the stand to one lateral side of the grill stove when lighting is needed for barbecue. The prior art is easily fixed on and removed from a grill stove for use.

However, the aforementioned lighting with magnet attachment of prior art is able to be used on a stove with magnetism, not on a stove which is made of stones, bricks, ceramics or other materials without magnetism.

### SUMMARY OF THE INVENTION

The primary purpose of the present invention is to provide a lighting installation for grill stove, which is able to be positioned on a panel of a grill stove made of any material to solve current technical problems.

To achieve the purpose, a lighting installation for grill stove of the present invention is disclosed herein. The lighting installation is set on a platform of a grill stove with a fixing surface arranged, comprising a base and a light set on the base; the base is positioned on the platform with a fixing surface arranged by a fastening piece and is flexibly removable from thereon. Moreover, seeing that the invention applies the fastening piece to position the base, the lighting installation of the invention is applicable to any platform with a fixing surface arranged made of any material, not limited to magnetic materials; mean while, the invention is convenient to be positioned or dismounted as the fastening piece is flexibly removable.

In an embodiment of the invention, the base is positioned on a corner of the platform with a fixing surface arranged by the fastening piece, such as a screw or being wedged, etc. The platform with a fixing surface arranged is generally formed as a square shape, therefore, the base is formed as a right angle with a “L”-shaped cross-sectional fixed piece and is able to be formed as a different shape, as long as the base is easily installed and removed.

To enable better illumination and easy installation, the light is positioned on the base by a light shaft to have better position for illumination. The light shaft is able to be preferably formed as either shape of, cylinder, cube, etc.

In an embodiment of the invention, a power cord is set on the bottom of the platform with a fixing surface arranged, the invention provides a cannular light shaft enabling the power cord to pierce through and connect a plug set on the bottom of the light shaft; in addition, the base has a socket set thereon to connect the plug. Upon installation of the invention, the light shaft is positioned on the base, enabling the plug to connect the plug and generate light. The power cord is able to connect main electricity or battery for power supply as necessary.

To assure electricity safety during barbecue, the plug and the socket of the invention are respectively covered by insulated plastics. The light is installed in and protected by the light shade and connect the light shaft, preventing the light bulb from breaking into shatters due to external force or error operations.

If necessary, the light angle is able to be adjustable up and down, therefore, the light shade and the light shaft connect together by a “U”-shaped bracket, in addition, the light shade is pivotally set on both lateral sides of the bracket and is revolvable up and down for a user to find a suitable light angle for barbecue.

Moreover, the bracket is fixed on the light shaft and is able to sway left or right, so that a user is able to move the bracket to the left or right direction for illumination angle. In the embodiment, the invention enables the bracket to be fixed on the light shaft by screw threads.

Compared with said prior art, the invention is applicable to the base and the platform with a fixing surface arranged that are made of either magnetic or non-magnetic materials. Consequently, the invention enables a wider application of the light on the grill stove, moreover, easy installation and dismantle.

### BRIEF DESCRIPTION OF THE DRAWINGS

FIG. 1 is a perspective view showing the assembly of a lighting installation for grill stove of the present invention.

FIG. 2 is an exploded view of the present invention.

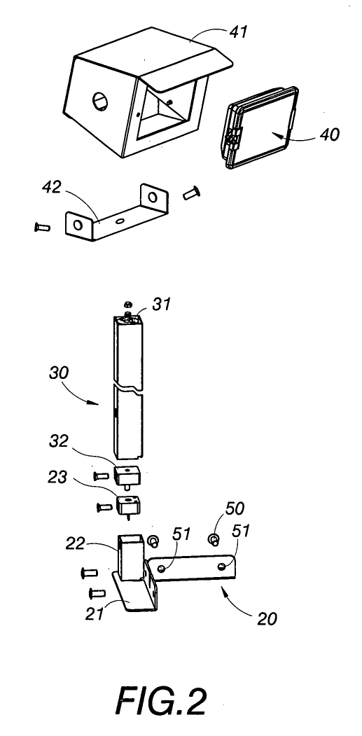

FIG. 3 is a perspective view showing the assembly of the present invention.

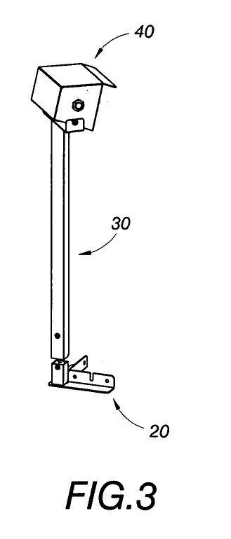

### DETAILED DESCRIPTION OF THE PREFERRED EMBODIMENTS

A detailed description is given in the following embodiments with reference to the accompanying drawings.

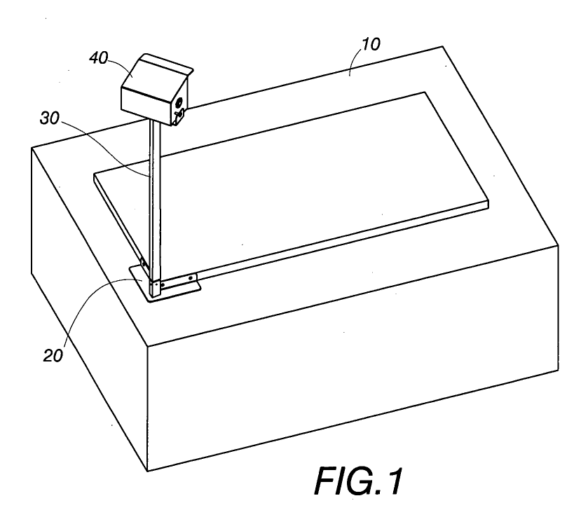

With reference to FIG. 1, the light installation of the invention is positioned on one lateral side of a platform 10 with a fixing surface arranged. As shown that the platform 10 is formed as a rectangle shape, the invention is able to be installed on either corner of the platform 10. The invention further comprises a base 20, a light shaft 30, and a set of light 40.

As shown in FIGS. 1˜3, the light 40 is positioned inside a light shade 41, which is pivotally set on both lateral sides of a “U”-shaped bracket 42. The bracket 42 has the bottom thereon fixed on the light shaft 30 by at least a bolt and a nut.

The light shaft 30 is formed as a cannular rectangular shape, with an opening 31 set inside thereof, a power cord (not shown) that connects the light 40 pierces through the opening 31, in addition, the bottom of the light shaft 30 connects a plug 32. The shape of the plug 32 matches that of the light shaft 30, i.e., a rectangular shape, so that the plug is fixed on the bottom of the light shaft 30 to connect the power cord inside the opening 31.

As shown that the shape of the bottom of the base 20 is a right angle with a “L”-shaped cross-sectional fixed piece 21, positioning holes 51 are set on the vertical side of the fixed piece 21 for a fastening piece 50 to position the base 20 on the platform 10. A pipe 22 is set on the top of the fixed piece 21 with a suitable shape coupling with the shape of the light shaft 30, enabling a power source to provide electricity through the connection of the plug 32 and the socket 23. In the embodiment, the fastening piece 50 is at least a screw.

When the light is necessary during barbecue, the base 20 is positioned on a corner of the platform 10 by the fastening piece 50, subsequently, the plug 32 on the bottom of the light shaft 30 connects the socket 23 on the base 20, in addition, the light shaft 30 is fixed on the base 20. the electricity is supplied to the light 40 due to the connection of the plug 23 and the socket 32.

If the illumination angle of the light 40 needs to be adjusted, the invention enables the light shade 41 to pivotally set on both lateral sides of the bracket 42, thereby the light shade 41 is able to be adjusted up and down for adjusting the illumination angle of the light 40. In addition, the bracket 42 and the light shaft 30 are connected by at least a bolt and a nut, therefore, the bracket 42 is able to sway to the left or right for adjusting the illumination angle of the light 40.

The prevent invention provides an improved lighting installation for grill stove, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A lighting installation for grill stove, positioned on a platform with a fixing surface arranged of said grill stove, comprising
a base, positioned on said platform with a fixing surface arranged by a dismountable fastening piece; and
a light, installed on said base.

2. The lighting installation for grill stove as claimed in claim 1, wherein the base is positioned on a corner of said platform with a fixing surface arranged, and said fastening piece is at least a screw.

3. The lighting installation for grill stove as claimed in claim 1, wherein the base forms a right angle on the bottom thereon with a “L”-shaped cross-sectional fixed piece.

4. The lighting installation for grill stove as claimed in claim 1, wherein the light is fixed on the base by a light shaft.

5. The lighting installation for grill stove as claimed in claim 4, wherein the light shaft is a cannular column with an opening inside thereof, a power source of the light pierces through said opening and connects a plug on the bottom thereof, said plug connects with a socket set on the base.

6. The lighting installation for grill stove as claimed in claim 3, wherein the light is positioned inside the light shade, which connects said light shaft.

7. The lighting installation for grill stove as claimed in claim 6, wherein the light shaft has a “U”-shaped bracket set on the top thereof, the light shade is pivotally positioned on both lateral sides of a bracket and revolvable up and down.

8. The lighting installation for grill stove as claimed in claim 7, wherein the bracket is fixed on said light shaft and is able to flexibly sway to either left or right.

9. The lighting installation for grill stove as claimed in claim 8, wherein the bracket is fixed on said light shaft on the bottom thereof by a bolt and a nut.
